(19) United States
(12) Patent Application Publication
(10) Pub. No.: US 2015/0158546 A1
(43) Pub. Date: Jun. 11, 2015

(54) Pluggable axle assembly for a wheel, in particular for a bicycle wheel

(71) Applicant: Derby Cycle Werke GmbH, Cloppenburg (DE)

(72) Inventor: Fabian SCHOLZ, Stuttgart (DE)

(21) Appl. No.: 14/555,805

(22) Filed: Nov. 28, 2014

(30) Foreign Application Priority Data
Nov. 29, 2013 (DE) 20 2013 009 812.0

(51) Int. Cl. B62K 25/02

(52) U.S. Cl. CPC B62K 25/02

(57) ABSTRACT

A plug-axis device for a wheel, particularly for a wheel of a bicycle, comprising an axis portion for the impeller, which is equipped with an actuating device and with a connecting device fixed rigidly to the impeller receiving parts, characterized in that the connecting device and the actuating means at opposite free ends of the axis portion are arranged and respectively connected to the axis portion are rotationally connected.

The invention relates to a pluggable axle assembly for a wheel, in particular for a bicycle wheel, comprising an axle section for the wheel, which is equipped with an actuator and connector so as to firmly abut against components that accommodate the wheel.

Vehicles, in particular two-wheelers, and of those in particular bicycles, exhibit wheels. The wheels each have a hub, rims joined with this hub, as well as tubes and tires or even tubeless tires. The hub and rim of the wheel are routinely joined together by way of spokes.

The hub is situated on an axle, around which the wheel can turn during a forward movement of in particular the bicycle. Known in prior art are axles that are placed in the hubs of wheels, and to this extent are connected thereto. Also known are generic pluggable axle assemblies arranged separately from the wheels.

A pluggable axle assembly can be routed from outside through sections of the components accommodating the wheel and the hub of the wheel, and then be joined with the components accommodating the wheel. The advantage is that the wheel can be rapidly assembled, and in particular rapidly disassembled, especially in the event of an accident. For example, components accommodating the wheel include sections of a vehicle frame, if necessary dropouts of a bicycle frame situated on chain stays.

The object of the invention is to indicate a pluggable axle assembly that has a simple design and exhibits few components.

This object is achieved according to the invention by virtue of the fact that the connector and actuator are located at opposing free ends of the axle section, and each joined in a torque-proof manner with the axle section.

As in prior art, the axle assembly according to the invention exhibits an actuator to fix it in place and a connector for joining it with the components accommodating the wheel. In the invention, the latter are located at opposing free ends of the axle section, and thus only there. These respective components are joined in a torque-proof manner with the axle section, so that no components are routed through the axle section. The axle section alone joins the actuator and connector to each other.

The design of the axle assembly according to the invention is simplified in this way, wherein the axle section serves to accommodate the hub of the wheel on the one hand, and can convey actuating forces introduced by the actuator to the connector on the other.

A first further development of the invention provides that the axle section is a hollow axle at least in sections. A sectional design as a hollow axle is sufficient to allow components of the connector and actuator to be introduced into the free ends of the axle section and into hollow axle sections located there.

For example, the actuator has a shaft that is introduced into the free end of the axle section, and engaged by a lever element. The lever element can be used to change the position of the shaft, and hence of the axle section, so as to achieve a fixed clamping to components accommodating the wheel.

In a further development of the invention, the connector can have a cam configuration that can be made to varyingly abut against a cam receptacle located in the component for the wheel. The varying abutments can be achieved by rotating the cam configuration, wherein this rotation is imparted to the cam configuration via the axle section proceeding from the actuator. The varying abutments can yield a detachable abutment and a fixed abutment.

Also provided to further develop the invention is that the cam receptacle is a locking element, which is placed in a dropout for the wheel, and has two angular positions for the cam configuration. One angular position can be used to fix the cam configuration in place, while the other angular position can allow for its removal. In this regard, the cam receptacle forms a kind of bayonet catch for the cam configuration.

The drawing presents an exemplary embodiment of the invention, from which additional inventive features are derived. Shown on:

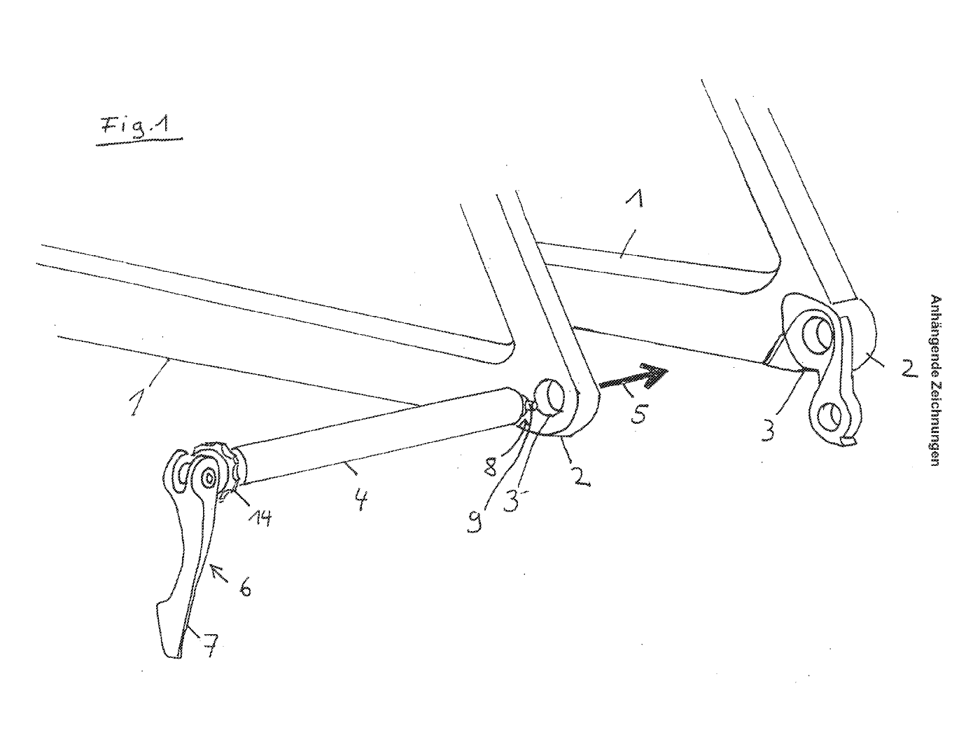

FIG. 1 to FIG. 4 is a respective perspective partial view of a bicycle frame with a pluggable axle assembly according to the invention,

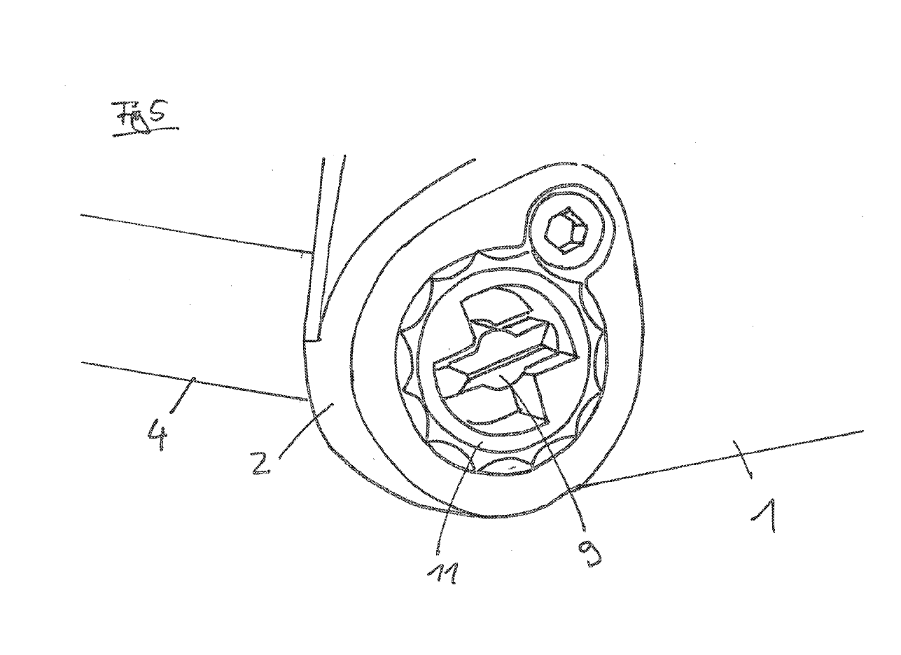

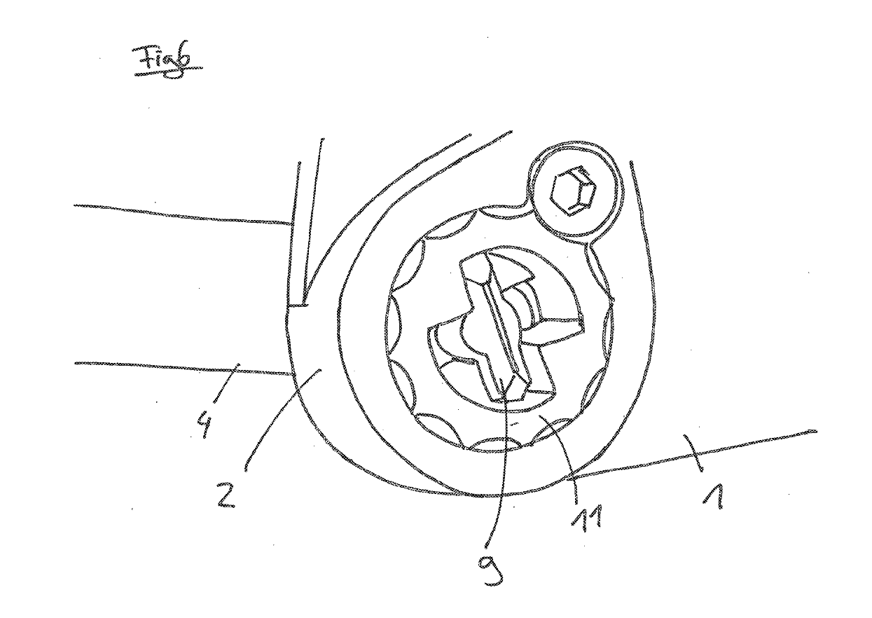

FIG. 5 and FIG. 6 is a perspective partial view of the bicycle frame with the axle assembly in differing angular positions, and

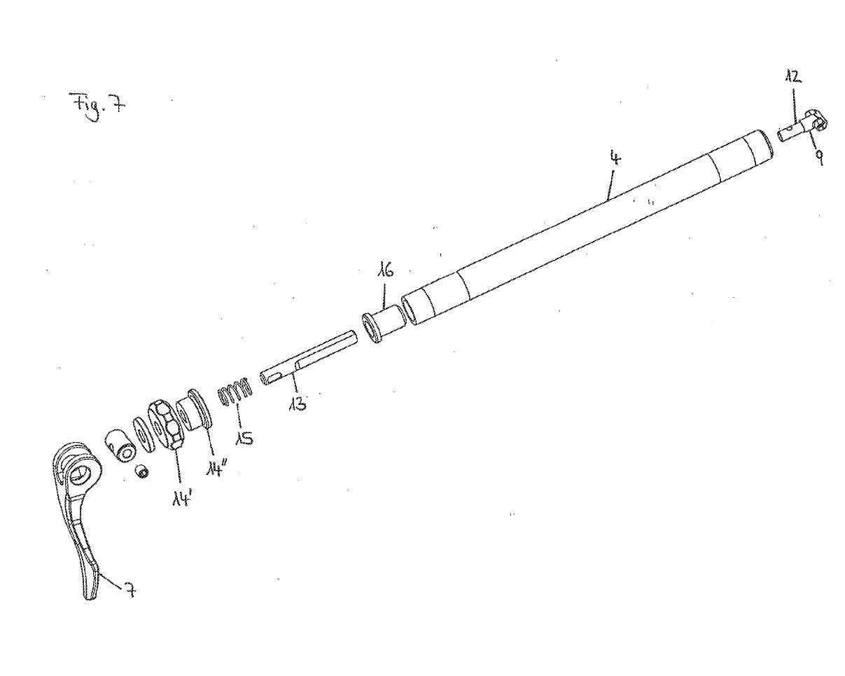

FIG. 7 is a perspective, exploded view of the axle assembly according to the invention.

FIG. 1 shows a partial view of the lower chain stays 1 of a bicycle frame, which pass over into upper chain stays in the area of dropouts 12 (not depicted in any more detail). The dropouts 2 have openings 3, through which an axle section 4 of the axle assembly according to the invention can be passed, arrow 5.

One free end of the axle section 4 has an actuator 6, which encompasses a locking lever 7. A connector 8 is located at the other free end of the axle section 4. The connector 8 encompasses a cam configuration 9 with laterally protruding cams.

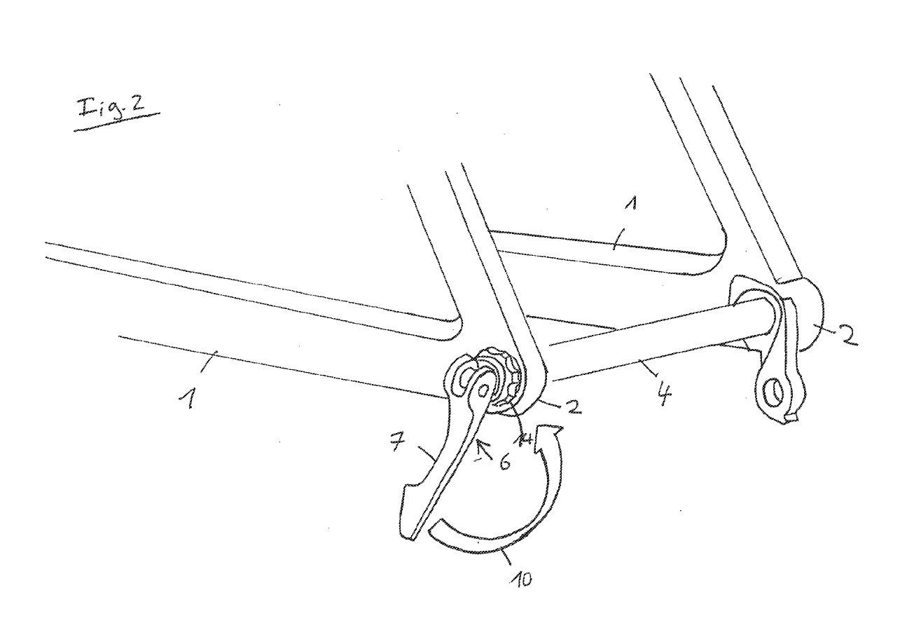

In FIG. 2, the axle section 4 is routed through the openings 3 in the dropouts 2, with the locking lever 7 still in the detached position. The axle section 4 can now be turned with the locking lever 7 along arrow 10, during which the cam configuration 9 is turned, FIG. 5 and FIG. 6.

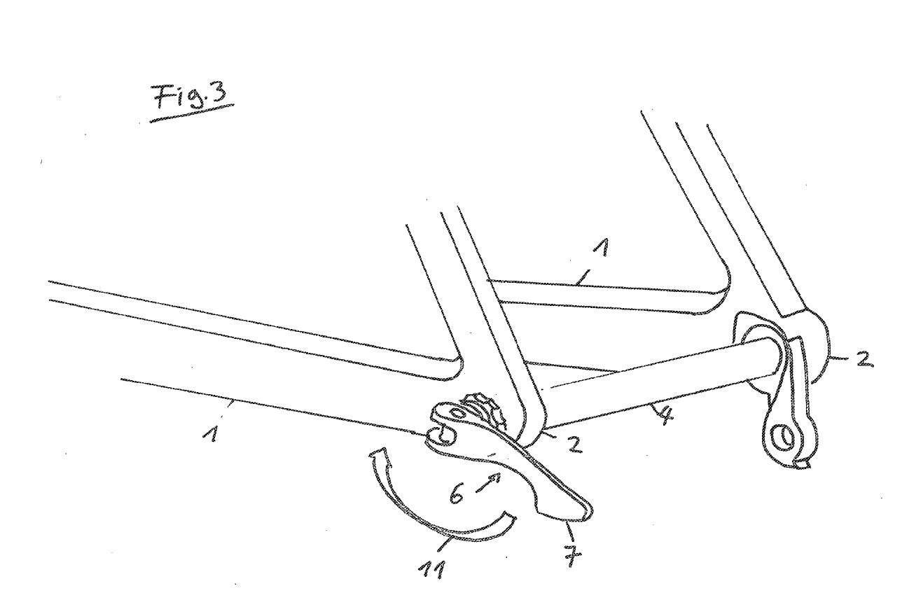

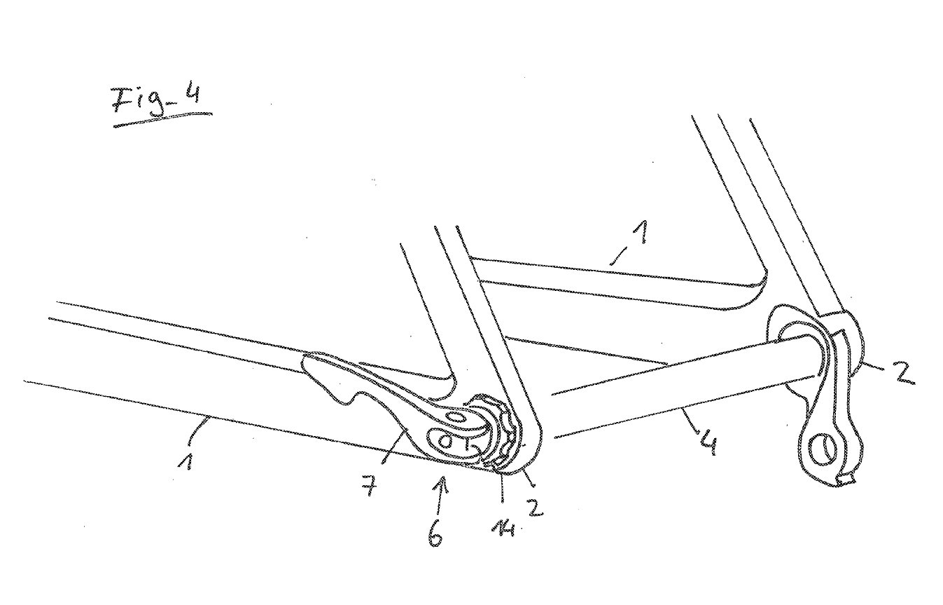

FIG. 3 shows the end point of rotation for the axle section 4 with the locking lever 7. The rotation took place over about 90°, and the locking lever 7 can now be swiveled along arrow 11 and thereby moved into its locked position, which is depicted on FIG. 4. In this position, the axle section 4 is shifted toward the locking lever 7, while the cam configuration 9 has become immovably abutted against the dropout 2 of the chain stay 1.

Visible on FIG. 5 is the cam configuration 9 of the axle section 4, which has here been introduced into a cam receptacle 11. The cams of the cam configuration 9 are here also allocated to openings. In the state depicted on FIG. 5, the connector is not yet closed. The state shown on FIG. 5 corresponds to the angular position of the axle section 4 depicted on FIG. 2.

FIG. 6 then shows the angular position of the axle section 4 from FIG. 3 and FIG. 4. The cam configuration 9 is rotated, engaging into the cam receptacle 11 behind undercuts. The locking lever 7 is used to pull the cam configuration 9 against the cam receptacle 11, thereby yielding a non-positive connection between the axle section 4 and dropouts 2 of the chain stays 1.

FIG. 7 depicts the individual components of the axle assembly with axle section 4 and cam configuration 9 according to the invention. The cam configuration 9 has a section 12 that can be incorporated on the free end of the axle section 4 in a torque-proof manner.

Allocated to the other free end of the axle section 4 is a shaft 13, on which clamping elements 14 can be displaced with the locking lever 7 against a spring 15. The clamping elements 14′, 14″ serve to compensate for the play and tolerances of the frame components and pluggable axle assembly. A clamping element 14″ is secured to the shaft 13 in a torque-proof manner, while the other clamping element 14′ can rotate. The distance between the locking lever 7 and dropout 2 can be varied with this clamping element 14′. The shaft 13 is here introduced into the free end of the axle section 4 in a torque-proof manner by means of a flange component 16.

1. A pluggable axle assembly for a wheel, in particular for a bicycle wheel, comprising an axle section for the wheel, which is equipped with an actuator and connector so as to firmly abut against components that accommodate the wheel, wherein the connector and actuator are located at opposing free ends of the axle section, and each joined in a torque-proof manner with the axle section.

2. The axle assembly according to claim 1, wherein the axle section is a hollow axle at least in sections.

3. The axle assembly according to claim 1, wherein the actuator has a shaft that is introduced into the free end of the axle section, and engaged by a lever element.

4. The axle assembly according to claim 1, wherein the connector has a cam configuration, which can be made to varyingly abut against a cam receptacle located in the component for the wheel.

5. The axle assembly according to claim 4 the cam receptacle is a locking element, which is placed in a dropout for the wheel, and has two angular positions for the cam configuration.
